(19) United States
(12) Patent Application Publication
(10) Pub. No.: US 2022/0318326 A1
(43) Pub. Date: Oct. 6, 2022

(54) PERSONALIZED CONTENT CURATION SYSTEM AND CONTENT PROPOSAL METHOD BASED ON BOOKMARK HISTORY

(71) Applicant: PIKURATE, LTD., Seoul (KR)

(72) Inventors: Seokkue SONG, Gimpo-si (KR); Sunghyuk PARK, Seoul (KR)

(21) Appl. No.: 17/712,229

(22) Filed: Apr. 4, 2022

(30) Foreign Application Priority Data
Apr. 2, 2021 (KR) 10-2021-0043193

(51) Int. Cl. G06F 16/9535; G06F 16/9537; G06F 16/955

(52) U.S. Cl. CPC G06F 16/9535; G06F 16/9537; G06F 16/9562

(57) ABSTRACT

A content curation system includes a communication module that receives search information associated with web content searched in a device of at least one user, wherein the at least one user comprises at least a first user and a second user; a metadata generation module that generates metadata corresponding to the search information received by the communication module based on a predetermined classification method; a similarity evaluation module that evaluates similarity between the search information based on the search information and the metadata; a relationship defining module that evaluates proximity between users based on the similarity; and a recommendation module that that extracts search information from the second user, wherein the extracted search information satisfies predetermined recommendation conditions among the search information retrieved by the second user who has the proximity equal to or greater than a predetermined reference proximity with respect to the first user.

### CROSS-REFERENCE TO RELATED APPLICATION(S)

The present application claims priority from Korean Application No. 10-2021-0043193 filed on Apr. 2, 2021, which application is incorporated herein by reference in its entirety.

### TECHNICAL FIELD

The present disclosure relates to a content curation system and content proposal method that can recommend and provide contents in consideration of individual interest based on bookmark history.

### RELATED ART

Internet users freely consume news, blogs, videos, and corporate website contents they want. Among the various contents, Internet users store via the bookmark function the path information (e.g., URL) so that it can be accessed again later (e.g., registered Korean patent publication No. 10-2214990, registered on Feb. 4, 2021).

However, conventional services simply allow users to store bookmarks, or simply provide a service that can share one's bookmarks with others, and do not recommend or provide personalized contents using bookmarks. Accordingly, there was an inconvenience that users should continue to search the contents of interest.

### SUMMARY

The present disclosure is to solve the above-described problems and to provide a personalized content curation system and content suggestion method based on the bookmark history by providing personalized contents that are customized based on the bookmarks such that the user's search convenience may be improved. However, the technical advantages to be achieved are not limited to the ones described above, and there may be other technical advantages.

According to an exemplary embodiment of the present disclosure, a content curation system may include a communication module that receives search information that is associated with web content that has been searched in a user device of at least one user (e.g., a first user, a second user, and so on to an N-th user, where N is a natural number equal to or greater than three); a metadata generation module that evaluates metadata that corresponds to the search information transmitted to the communication module based on a predetermined classification method; a similarity evaluation module that evaluates similarity between the search information based on the search information and the metadata; a relationship defining module that evaluates proximity between users based on the similarity; and a recommendation module that extracts search information from the second user, wherein the extracted search information satisfies predetermined recommendation conditions among the search information retrieved by the second user who has the proximity equal to or greater than a predetermined reference proximity with respect to the first user, to recommend search information of other users to the first user.

Further, the predetermined classification method may evaluate nature of the search information based on compositions and frequencies of words constituting the search information.

The content curation system may further include a networking module that connects search information having the similarity equal to or greater than a predetermined threshold similarity with one another on the network.

The content curation system may further include a package setting module that defines a representative keyword that is representative of search information for each of the search information, and categorizes the search information into packages based on the presentative keyword. The package setting module may categorize a plurality of pieces of search information of one user into a plurality of packages.

Further, the recommendation module may evaluate the similarity between the packages and, to recommend search information of other users to the first user, may select search information belonging to a package of the second user who has the proximity (e.g., the similarity measure) equal to or greater than the predetermined threshold proximity with respect to the first user.

Further, to recommend search information of other users to the first user, the recommendation module may select search information that belongs to the package of the second user who has the proximity equal to greater than the predetermined threshold proximity with respect to the first user, but is not similar to search information of the first user.

Further, to recommend search information of other users to the first user, the recommendation module may select search information in consideration of a preferred time specified for each package.

The content curation system may further include a storage module, and in response to detecting that no preferred time is stored in the storage module for a package, the recommendation module may set a preferred time of the package using a preferred time of a most similar package among the packages in which preferred times are stored in the storage module.

The search information may include content information including text data, image data, or sound data as well as address information that is associated with a location of the content information.

According to an exemplary embodiment of the present disclosure, a content proposal method for recommending contents using a content curation system may include (a) receiving, by a communication module, search information associated with web content searched in a device of at least one user, wherein the at least one user comprises a first user, a second user, and an N-th user, N being a natural number equal to or greater than three; (b) generating, by a metadata generation module, metadata corresponding to the search information received by the communication module based on a predetermined classification method; (c) evaluating, by a similarity evaluation module, similarity between the search information based on the search information and the metadata; (d) evaluating, by a relationship defining module, proximity between users based on the similarity; and (e) extracting, by a recommendation module, search information from the second user, wherein the extracted search information satisfies predetermined recommendation conditions among the search information retrieved by the second user who has the proximity equal to or greater than a predetermined reference proximity with respect to the first user, to recommend search information of other users to the first user.

According to the personalized content curation system and content suggestion method of the present disclosure based on bookmark history may improve users' content accessibility. The browsing convenience of the users may also be improved. Further, the search accuracy of the users may be improved. However, the effects of the present disclosure are not limited to the above-described effects, and the effects not mentioned will be clearly understood to those of ordinary skill in the art to which the present disclosure pertains from the present specification and the accompanying drawings.

### BRIEF DESCRIPTION OF THE DRAWINGS

FIG. 1 schematically describes a content curation system and external devices according to an exemplary embodiment of the present disclosure;

FIG. 2 is a block diagram showing an example of configuration for the content curation system according to an exemplary embodiment of the present disclosure;

FIG. 3 is a flowchart for a content curation proposal method according to an exemplary embodiment of the present disclosure;

FIG. 4 schematically explains a step of evaluating similarity between contents in the content curation proposal method according to an exemplary embodiment of the present disclosure;

FIGS. 5 and 6 schematically explain a step of setting packages in the content curation proposal method according to an exemplary embodiment of the present disclosure; and

FIG. 7 schematically explains a step of recommending content in the content curation proposal method according to an exemplary embodiment of the present disclosure.

### DETAILED DESCRIPTION

Hereinafter, specific exemplary embodiments of the present disclosure will be described in detail with reference to the drawings. However, the idea of the present disclosure is not limited to the exemplary embodiments presented, and those skilled in the art understanding the ideas of the present disclosure will be able to derive other embodiments that are included within the scope of the present disclosure or other regressive invention through addition, alteration, deletion, or the like.

In addition, components having the same function under the same idea will be described using the same reference numeral in the drawings of each exemplary embodiment.

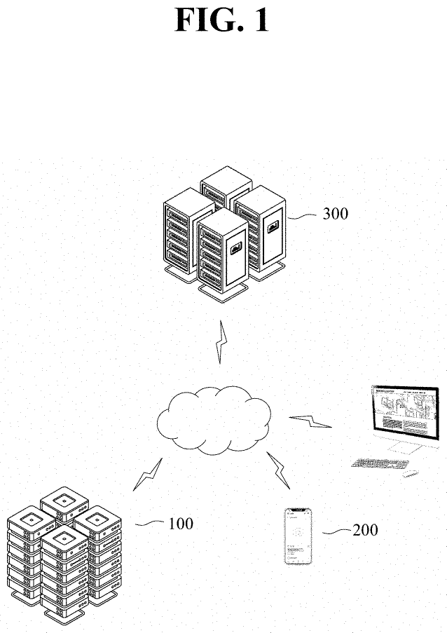

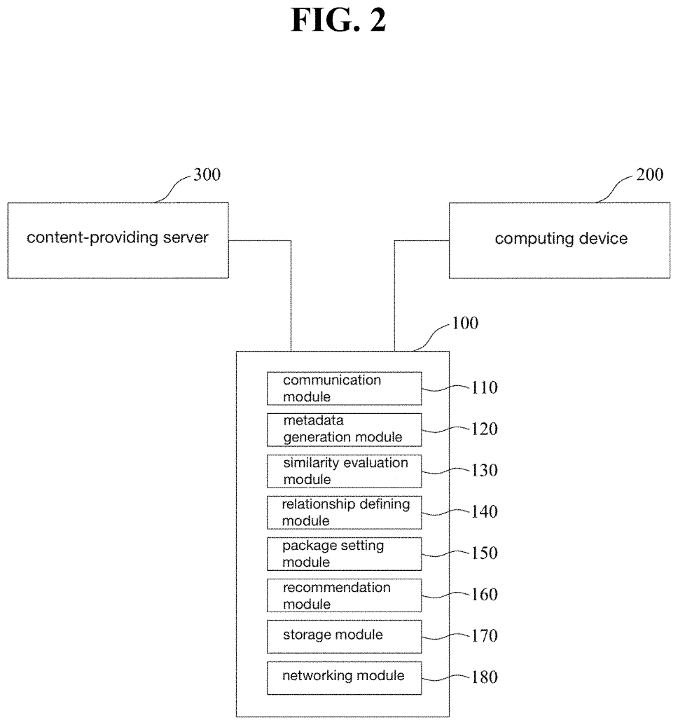

FIG. 1 shows a content curation system 100 according to an exemplary embodiment of the present disclosure and a relationship with external devices, and FIG. 2 is a block diagram showing an example of configuration for the content curation system 100 according to an exemplary embodiment of the present disclosure.

Referring to FIGS. 1 and 2, the content curation system 100 according to an exemplary embodiment of the present disclosure may be connected to a content-providing server 300 that provides contents through a computing device 200 and a network.

The computing device 200 may include a device capable of information processing operations. For example, the computing device 200 may include a desktop computer, a laptop computer, a smartphone, a personal digital assistant (PDA), a portable multimedia player (PMP), a mobile terminal including a portable terminal, a smart TV, or the like. Further, at least one user may be involved.

The content-providing server 300 may provide contents to other devices. The content-providing server 300 may include other configurations to function as a server. The content-providing server 300 may be implemented as various devices. For example, the content-providing server 300 may be a digital device, which is equipped with a processor and a memory, such as a laptop computer, a notebook computer, a desktop computer, a tablet, and a mobile phone, which are capable of computation. For example, the content-providing server 300 may be a web server. However, the present disclosure is not limited thereto, and the type of content-providing server 300 may be variously implemented.

The content curation system 100 may be connected to the computing device 200 and the content-providing server 300 in a wired and/or wireless manner. A communication network may be a core network integrated with a wired public network, a wireless mobile network, or the mobile Internet. The communication network may include a global open computer network structure that provides TCP/IP protocols and various services present at its higher layer, such as hyper text transfer protocol (HTTP), hyper text transfer protocol secure (HTTPS), Telnet, file transfer protocol (FTP), domain name system (DNS), and simple mail transfer protocol (SMTP). However, the communication network for the content curation system 100 according to the exemplary embodiment of the present disclosure is not limited thereto, and it may comprehensively include a data network capable of transmitting and receiving data in various forms.

The content curation system 100 according to an exemplary embodiment of the present disclosure may include a communication module 110 that receives search information associated with web content retrieved from a user device of at least one user. Here, the at least one user may include a first user, a second user, and so on, to an N-th user, where N is a natural number equal to or greater than three (3).

The content curation system 100 may also include a metadata generation module 120 that generates metadata that corresponds to the search information transmitted to the communication module 110 based on a predetermined classification method; a similarity evaluation module 130 that evaluates a similarity among the search information based on the search information and the metadata; a relationship defining module 140 that evaluates a proximity between the users based on the similarity; and a recommendation module 160 that extracts search information that satisfies predetermined recommendation conditions from the search information of the second user, who has a proximity equal to or greater than a predetermined reference proximity with respect to the first user, in order to recommend search information of other users to the first user.

The content curation system 100 may further comprise a networking module 180 that connects a plurality of pieces of search information having information similarities equal to or greater than a predetermined threshold similarity to one another on the network. The content curation system 100 may further comprise a package setting module 150 that defines a representative keyword for each of the search information that can represent one piece of the search information, and classifies the search information into packages based on representative keywords. The content curation system 100 may further comprise a storage module 170, in which data necessary for implementing the content curation proposal method are stored.

The communication module 110 may refer to a module capable of transmitting and receiving data with an external device, such as a content-providing server 300 and/or a user's computing device 200. For example, the communication module 110 may include a cellular module, a Wi-Fi module, a Bluetooth module, a GNSS module, an NFC module, an RF module, a 5G module, an LTE module, an NB-IOT module and/or a LoRa module. However, the present disclosure is not limited thereto, and the communication module 110 may be variously implemented.

The storage module 170 may include one or more internal memories and/or one or more external memories. For example, the internal memory may include at least one of volatile memory (e.g., DRAM, SRAM, or SDRAM), nonvolatile memory (e.g. one time programmable ROM (OTPROM), PROM, EPROM, EEPROM, mask ROM, or flash ROM), flash memory, hard drive, or solid state drive (SSD). The external memory may include flash drives, such as compact flash (CF), secure digital (SD), micro-SD, mini-SD, extreme digital (xD), multi-media card (MMC), or memory sticks.

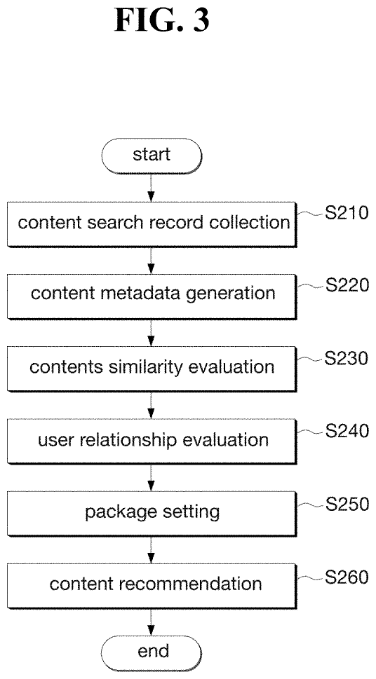

FIG. 3 is a flowchart for a content curation proposal method according to an exemplary embodiment of the present disclosure. Referring to FIG. 3, the content curation proposal method according to an exemplary embodiment of the present disclosure may include a content search record collection step S210, in which a communication module 110 receives search information associated with web content retrieved from a user device 200 of at least one user. Here, the at least one user may include a first user, a second user, and so on, to an N-th user, where N is a natural number equal to or greater than three (3).

Subsequently, the content curation proposal method may further include a content metadata generation step S220, in which a metadata generation module 120 generates metadata that corresponds to the search information based on predetermined classification methods; a similarity evaluation step S230, in which a similarity evaluation module 130 evaluates similarities among the search information based on the search information and the metadata; and a user relationship evaluation step S240, in which a relationship defining module 140 evaluates proximities between users based on the similarity. Further, in order to recommend search information of other users to the first user, the content curation proposal method may include a content recommendation step S260, in which a recommendation module 160 extracts search information that satisfies predetermined recommendation conditions among the search information searched by the second user who has a proximity equal to or greater than a predetermined reference proximity with respect to the first user.

In addition, the content curation proposal method may further comprise a package setting step S250, which defines a representative keyword for each of the search information that can represent one piece of the search information, and classifies the search information into packages based on the representative keywords.

Hereinbelow, each step will be described in more detail.

In the content search record collection step S210, the communication module 110 may collect search information from external devices 200 of users. The users may designate or register one or more addresses of web pages that the users are interested in as bookmarks or “favorites” on their respective computing devices 200. Information about the address of a web page stored on a user's computing device 200 may be referred to as address information. For example, the address information may include a URL.

The computing device 200 may transmit the address information to the content curation system 100. Further, the computing device 200 may transmit the address information along with content information, which corresponds to the address information, to the communication module 110. The content information may refer to texts, images, and/or voice data posted on the web page that can be accessed using the address information. The content information may herein also be referred to as “content(s).”

In some embodiments, when the communication module 110 receives the address information from the user's computing device 200, the communication module 110 may access the web page using the address information and may collect the content information.

The search information may include the content information including text data, image data, or sound data, as well as the address information about the location of the content information.

In the content metadata generation step S220, the metadata generation module 120 may use the search information to generate metadata therefrom. The metadata generation module 120 may analyze compositions of words and frequencies of keywords included in the content information, and interpret the nature of the search information based thereon. For example, the metadata generation module 120 may analyze the nature of the search information based on TF-IDF analysis techniques.

For example, the nature of the search information may be about “attributes” of the content information. For example, the nature of the search information may be divided into categories of the main content, for example, household appliances, travel, fashion, engineering, etc. The nature of the search information may be divided based on the purpose of the web document, for example, descriptions, advertisements, editorials, articles, etc. However, the present disclosure is not limited thereto, and the method of classifying the nature of the search information may be variously modified.

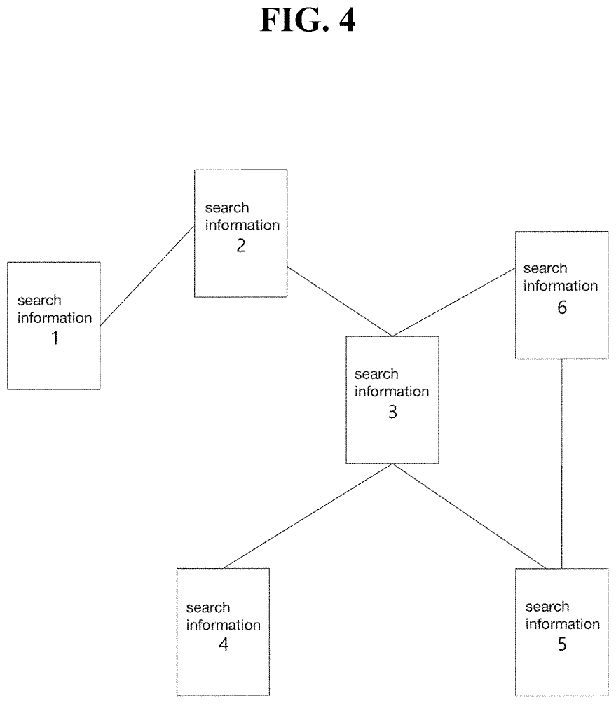

FIG. 4 schematically explains the similarity evaluation step S230 between contents in the content curation proposal method according to an embodiment of the present invention. Referring to FIG. 4, in the similarity evaluation step S230, the similarity evaluation module 130 may evaluate a degree of similarity between the search information based on the search information and the metadata. To that end, one or more predetermined classification methods may evaluate the nature of the search information based on the compositions and frequencies of words that constitute the search information. A degree of similarity between the search information may be evaluated using one or more predetermined similarity determination algorithms. Description of the algorithms for determining the similarity between web documents is omitted since algorithms known in the field may be used. In some embodiments, the metadata may also be used when determining the similarity between web documents.

The networking module 180 may network a plurality of pieces of the search information with one another having similarities equal to or greater than a predetermined threshold similarity. For example, if the similarity between the search information is quantified in a range of 0 to 100, where higher values mean higher degrees of similarity, the predetermined threshold may be set to 80. However, the present disclosure is not limited thereto, and the method of representing the predetermined threshold similarity may be variously modified. The description that the pieces of search information are connected over the network may mean that certain information is stored in the storage module 170, the information representing that a particular group of the address information each associated with each search information is related with one another.

In the user relationship evaluation step S240, the relationship defining module 140 may evaluate a degree of proximity (e.g., a similarity measure) between the users. The relationship defining module 140 may evaluate the degree of proximity between the users based on the degree of similarity of the search information of each user. The higher the similarity between two users' search information, the higher the proximity between the two users may be. Conversely, the lower the similarity between two users' search information, the lower the proximity between the two users may be. For example, the relationship defining module 140 may quantify the degree of proximity in a range of 0 to 100 based on an average of similarities between each of the search information.

By way of example, a first user may store search information 1-1 and search information 1-2 in his or her computing device, the second user may store search information 2-1 and search information 2-2 in his or her computing device, and each of the search information may be transmitted to the communication module. Here, the similarity between the search information 1-1 and the search information 2-1 may be 90, the similarity between the search information 1-1 and the search information 2-2 may be 40, the similarity between the search information 1-2 and the search information 2-1 may be 85, and the similarity between the search information 1-2 and the search information 2-2 may be 55. In this case, the proximity between the first user and the second user may be calculated to be ((90+40)/2+(85+55)/2)/2)=67.5. However, the present disclosure is not limited thereto, and the method for evaluating the degree of proximity between the users may be variously modified.

Subsequently, the relationship defining module 140 may designate users who have a proximity therebetween equal to or greater than a predetermined reference proximity as similar users or proximate users. For example, the predetermined reference proximity may be 80. However, the present disclosure is not limited thereto, and the value for the reference proximity may be variously modified. The relationship defining module 140 may update the storage module 170 by evaluating the proximities between users in real time based on the search information uploaded from the users.

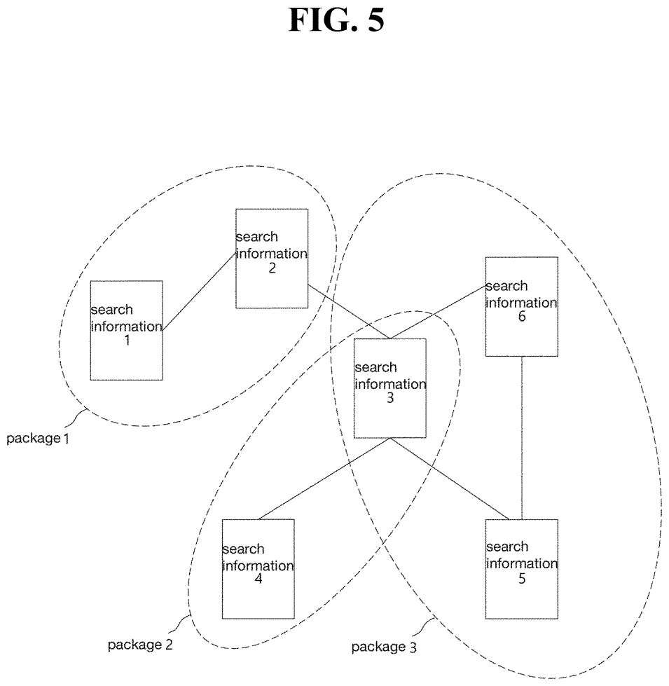

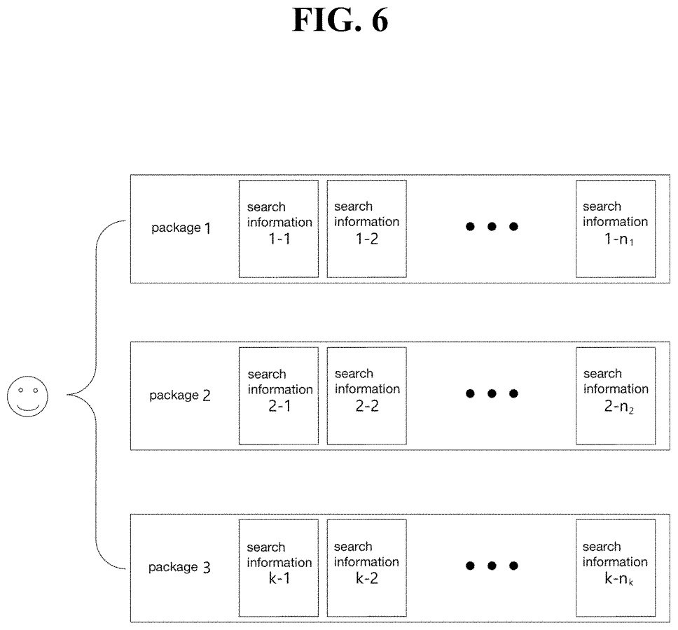

FIGS. 5 and 6 schematically explain the package setting step S250 of the content curation proposal method according to an embodiment of the present invention. Referring to FIGS. 5 and 6, in the package setting step S250, the package setting module 150 may classify the search information of a user into units of packages. The package setting module 150 may define keywords that are commonly and frequently appearing in the content and representative of the content as tags. For example, if the search information is blog content related to a first birthday party, the keywords such as “first birthday party,” “family event,” and “birthday” may be designated as representative keywords.

In some embodiments, the package setting module 150 may be configured to include one or more search information containing the representative keyword “first birthday party” in one package. Accordingly, each of the search information of the user may be classified on the basis of distinct packages.

The package setting module 150 may transmit the package list to the consumer computing device 200 via the communication module 110. The consumer computing device 200 may check the package list via a display device, examine whether the name (i.e., representative keyword) for each package is assigned correctly, examine whether the search information (e.g., bookmark) is classified into the packages appropriately, and then provide feedback. Consequently, based on the feedback from the consumer computing device 200, the package setting module 150 may modify and/or refine the package classification system.

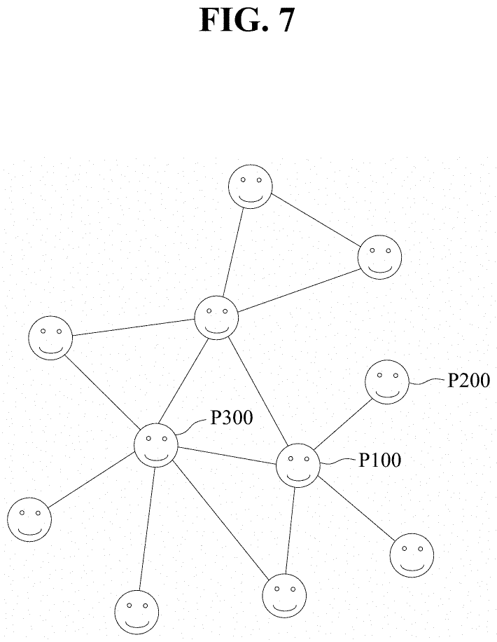

FIG. 7 schematically explains the content recommendation step S260 in the content curation proposal method according to an exemplary embodiment of the present disclosure. The recommendation module 160 may evaluate degrees of similarity between packages. The degrees of similarity between packages may be evaluated based on degrees of association between representative keywords. For example, attributes for representative keywords may be stored in the storage module 170, and the recommendation module 160 may determine the similarities between the attributes. Description of methods for determining similarity is omitted since known methods may be used.

In order to recommend search information of other users to the first user, the recommendation module 160 may select search information that belongs to a package of another user who has a proximity of a predetermined reference or above with respect to the first user. In addition, in order to recommend search information of other users to the first user, the recommendation module 160 may select search information that belongs to a package of another user who has a proximity of a predetermined reference or above with respect to a package of the first user, but is not similar to the search information in the package of the first user.

Referring to FIG. 7, to describe with regards to the first user, users that are proximate to the first user with a predetermined reference proximity or higher may be evaluated. Subsequently, the recommendation module 160 may select one or more packages of other users, who are proximate to the first user with a predetermined proximity or higher, the one or more packages being similar to a package of the first user. The recommendation module 160 may make a recommendation to the first user by extracting the search information that is not similar to the search information of the first user within the selected one or more packages. Accordingly, the search information, which the first user may be interested in but did not search, may be selectively recommended to the first user. Thus, for the first user, the routes to acquire information may be dramatically expanded.

The recommendation module 160, in order to recommend search information of other users to the first user, may select search information in consideration of time that is specified as a preferred time for each package. For this, the recommended module 160 may determine the preferred time for a package based on the attributes of the package. The preferred time determined based on the attributes of the package may be stored in the storage module 170. In case no preferred time is stored in the storage module 170 for a package, the preferred time of the most similar package among the packages in which the preferred times are stored in the storage module 170 may be presumed as the preferred time of that package. The recommendation module 160 may set the preferred time of the package using the preferred time of the most similar package among the packages in which the preferred times are stored in the storage module 170 in case no preferred time is stored in the storage module 170 for a package.

By way of example, packages of the first user (P100) may be classified as “English study,” “restaurant,” and “real estate”; packages of the second user (P200) may be classified as “English study,” “math study,” and “real estate”; and packages of the third users (P300) may be classified as “restaurant,” “yoga,” “movie,” and “apartment sales.” Here, the first user (P100), the second user (P200), and the third user (P300) may have proximities of a predetermined reference proximity or higher.

The preferred time for a package associated with “English study” may be 9:00 to 12:00, the preferred time for a package associated with “restaurant” may be 18:00 to 21:00, and the preferred time for a package associated with “apartment sales” may be 22:00 to 24:00. In such a case, if the preferred times for “English study” and “restaurant” are stored in the storage module, and no preferred time for “real estate” is stored in the storage module, the recommendation module 160 may set the preferred time for the package associated with “real estate” using the preference time of the package associated with “apartment sales,” which is the package that is most similar to the package associated with “real estate.”

Accordingly, the recommendation module 160 may recommend to the first user (P100) search information that is present within the second user's (P200) package associated with “English study” between 9:00 and 12:00. Further, the recommendation module 160 may recommend to the first user (P100) search information that is present within the third user's (P300) package associated with “restaurant” between 18:00 and 21:00. In addition, the recommendation module 160 may recommend to the first user (P100) search information that is present within the second user's (P200) package associated with “real estate” between 22:00 and 24:00.

Therefore, by appropriately recommending contents that fit the areas of interest of the users, the users' web surfing experience may be effectively improved.

Appended drawings may omit or briefly describe some configurations that are not relevant or less relevant to the technical ideas of the present disclosure, in order to more clearly describe the technical ideas of the present disclosure.

In the foregoing description, the configuration and characteristics of the present disclosure are described with reference to exemplary embodiments, but the present disclosure is not limited thereto. It is apparent to those skilled in the art pertinent to the present disclosure that the configuration and characteristics may be variously changed or modified within the ideas and scope of the present disclosure. Such changes or modifications fall within the scope of the attached claims.

What is claimed is:

1. A content curation system comprising:
a communication module that receives search information associated with web content searched in a device of at least one user, wherein the at least one user comprises at least a first user and a second user;
a metadata generation module that generates metadata corresponding to the search information received by the communication module based on a predetermined classification method;
a similarity evaluation module that evaluates similarity between the search information based on the search information and the metadata;
a relationship defining module that evaluates proximity between the first user and the second user based on the similarity; and
a recommendation module that extracts search information from the second user, wherein the extracted search information satisfies predetermined recommendation conditions among the search information retrieved by the second user who has the proximity equal to or greater than a predetermined reference proximity with respect to the first user.

2. The system of claim 1, wherein the predetermined classification method evaluates nature of the search information based on compositions and frequencies of words that constitute the search information.

3. The system of claim 1, further comprising:
a networking module that connects search information having the similarity equal to or greater than a predetermined threshold similarity with one another.

4. The system of claim 1, further comprising:
a package setting module that defines a representative keyword that is representative of search information for each of the search information, and categorizes the search information into packages based on the representative keyword,
wherein the package setting module categorized the search information of one user into packages.

5. The system of claim 4, wherein the recommendation module evaluates the similarity between the packages and selects search information belonging to a package of the second user who has the proximity equal to or greater than the predetermined threshold proximity with respect to the first user.

6. The system of claim 5, wherein the recommendation module selects search information that belongs to the package of the second user who has the proximity equal to or greater than the predetermined threshold proximity with respect to the first user, but is not similar to search information of the first user.

7. The system of claim 6, wherein the recommendation module selects search information based on a preferred time specified for each package.

8. The system of claim 7, further comprising:
a storage module configured to store preferred times for packages,
wherein in response to detecting that no preferred time is stored in the storage module for a package, the recommendation module sets a preferred time of the package using a preferred time of a most similar package among the packages in which preferred times are stored in the storage module.

9. The system of claim 1, wherein the search information comprises:
content information including text data, image data, or sound data; and
address information associated with a location of the content information.

10. A content curation proposal method for recommending contents using a content curation system, the method comprising:
receiving, by a communication module, search information associated with web content searched in a device of at least one user, wherein the at least one user comprises at least a first user and a second user;
generating, by a metadata generation module, metadata corresponding to the search information received by the communication module based on a predetermined classification method;
evaluating, by a similarity evaluation module, similarity between the search information based on the search information and the metadata;
evaluating, by a relationship defining module, proximity between the first user and the second user based on the similarity; and
extracting, by a recommendation module, search information from the second user, wherein the extracted search information satisfies predetermined recommendation conditions among the search information retrieved by the second user who has the proximity equal to or greater than a predetermined reference proximity with respect to the first user.
